(19) United States
(12) Patent Application Publication
(10) Pub. No.: US 2003/0147078 A1
(43) Pub. Date: Aug. 7, 2003

(54) Method for the long-term stable and well-reproducible spectrometric measurement of the concentrations of components of aqueous solutions, and device for carrying out said method

(76) Inventors: Kai-Uwe Zirk, Wildflecken (DE); Harald Potzschke, Wiesbaden (DE)

Correspondence Address: BANNER & WITCOFF, 1001 G STREET N W, SUITE 1100, WASHINGTON, DC, 20001, US

(21) Appl. No.: 10/258,175

(22) PCT Filed: Apr. 24, 2001
(86) PCT No.: PCT/EP01/04587

(30) Foreign Application Priority Data
Apr. 27, 2000 (DE) 100 20 615.8

(51) Int. Cl. G01N 21/59

(52) U.S. Cl. 356/432

(57) ABSTRACT

The invention relates to a method for the long-term stable and well-reproducible spectrometric measurement of the concentrations of components of aqueous solutions, especially of dialysates of interstitial tissue fluids, especially the glucose concentration. The inventive method comprises splitting a measuring beam into two partial beams by means of a beam splitter (2), and guiding one partial beam through a measuring cuvette (3), that is separated from the solution to be measured for example by a diaphragm, or that is connected to a pump system with an exchange path that is separated from the solution to be measured by a diaphragm. The other partial beam is guided through a reference cuvette (4) that is filled with a reference solution. The light intensity of both partial beams is measured and the measured signals are subjected to a symmetrical signal processing, optionally after suitable amplification. The invention further relates to a device for carrying out the inventive method, which device can be especially miniaturized.

The subject matter of the invention is a method exhibiting the features of claim 1, as well as a device for executing this method exhibiting the features of claim 6. A preferred area of application is the measurement of glucose concentrations in interstitial body fluids through use of the inventive device in a miniaturized design.

Normally, 100 ml of human blood contains between roughly 70 and 110 mg glucose. For diabetes milletus, a disease which afflicts about 3% of the adult population in industrial countries, the average glucose content in the patient's blood usually is distinctly elevated, since these patients suffer from a deficiency—absolute or relative—of the hormone insulin. Insulin lowers the glucose content in the blood by promoting its absorption in the body's cells. If the momentary blood glucose content of a diabetic can be monitored continuously and at any given moment, the patient will be able to introduce the exact quantity of deficient insulin and thereby normalize his glucose metabolism. This largely eliminates burdens placed on the organism and subsequent damage caused by the undesirable effects induced by an unstable glucose level, and this in turn leads to a general improvement in the patient's quality of life and a greater life expectancy. An implantable glucose sensor is one possibility for the continuous detection of the glucose concentration in the body. This heretofore missing component, when combined with a known insulin pump, would contribute decisively to the realization of a so-called “artificial pancreas”, i.e., a technical device for supplying insulin to the patient in a fully automatic manner. This kind of artificial pancreas would permit many diabetic patients to live without the need for insulin injections.

Research and development groups worldwide are making efforts to develop and bring to market an implantable glucose sensor for detecting glucose concentrations.

Different principles of measurement have been applied in the process. In a great preponderance of cases, electrochemical glucose sensors have been designed, tested, and developed. The use of such electrochemical sensors based on suitable enzymes within the body faces enormous difficulties. Among these in particular is the contamination of the employed enzymes (e.g., glucose oxidase) by substances belonging to the body, with a subsequent, long-term instability. To avoid this disadvantage the present invention deals exclusively with a purely physical principle of measurement, namely spectrometry.

If a light ray propagates in an absorbent medium, the luminous intensity I along the path s (in the context of linear optics) diminishes exponentially. Let a cuvette of layer thickness d, which is filled with the solution of an absorbent substance of concentration c, be penetrated by a light ray. The ratio of the intensity of the light ray leaving the cuvette with the light-absorbing substance in the cuvette (I(d)) to the corresponding value without this substance (Iₒ) is the transmission T, which can be calculated according the Lambert-Beer law as follows:

T=I(d)/Iₒ=^{-d·c·ε}

The proportionality factor ε is the absorption coefficient specific to the substance.

To achieve a resolution for, e.g., 3 mg/dL of the concentration of an aqueous glucose solution in a wavelength range around 1.6 μm of the measured radiation (which is infrared radiation in the NIR range, NIR: near infrared) over a measuring path of d=5 mm, it must be possible to register changes in the transmission of about 7·10⁻⁴ [T].

Given an average glucose content in the blood about 100 mg/dL, the indicated accuracy of detection corresponds to a relative error of about 3%. A greater degree of imprecision should not be tolerated, if technically possible.

Several methods and devices for the ex vivo measurement of the blood glucose level in the human body employing the specified principle as a method of measurement are known from patents WO 9510038, EP 0884970, U.S. Pat. No. 5,710,630, U.S. Pat. No. 5,222,496, U.S. Pat. No. 5,372,135, U.S. Pat. No. 5,638,816, U.S. Pat. No. 5,743,262, and U.S. Pat. No. 5,772,587. In all these processes, however, the “measuring ray” is radiated from the outside in or through tissue, and the change in absorption or the change in intensity of the scattered (reflected) radiation is employed as the measure for the glucose concentration. That is, none of these inventions deals with the development of an implantable glucose sensor, and all such measurements face fundamental difficulties, such as, e.g., sufficient specificity, due to the diversity of tissue structures.

Patents EP 0589191, EP 0561872, and U.S. Pat. No. 5,243,983, for example, disclose methods for determining spectrometrically the glucose concentration in the collyrium. Since the concentration in the collyrium adjusts itself very slowly to the actual blood glucose value, this method appears extremely unsuitable for a delay-free determination of the blood glucose level.

Another method and device for the quantitative determination of glucose are known from patent WO 9852469. According to this method, IR heat radiation emitted from the tympanic membrane contains spectral information on tissue composition and thus on the glucose concentration. Due to the enormous complexity and number of substances and structures present in the body, this method would also appear not to distinguish itself as a development ready for the market.

The present invention is based on the problem of making available a highly-sensitive, simple, and reproducible spectrometric method, along with corresponding devices, especially for the quantitative determination of glucose in interstitial bodily fluids, specifically in connection with an implantable detector. The method and device can also be used for other purposes, however, such as the monitoring and control of chemical processes.

When the absorptive substance is present only in a very small quantity, as is the case with glucose in the organism, a sufficient degree of accuracy in measuring the given content can be only provided by a very sensitive spectrometer, one of high optoelectronic quality with respect to the reception and amplification of the measuring signal. The device selected should have as simple a design as possible, i.e., one without movable parts, and should be miniaturized. The device must also contain the power of a large and quiet optoelectronic amplifier, in order to provide the required sensitivity and accuracy. Furthermore, measurement should be largely independent of the temperature of the substance under investigation, since influences of this kind are directly reproduced in the measuring signal.

None of the patents indicated above has yet proven to be the basis for a known and marketable technical development. The methods and devices described in the patents would appear to be unable to meet the specified demands, even for an ex vivo measurement.

The object of the invention and its teaching is to combine measuring arrangements that are known in principle or in part, but in a manner that is not obvious, and to thereby appreciably improve measuring accuracy, while simply and effectively solving the indicated problems and fulfilling the requirements for a detector used in the glucose measurement of bodily fluids. This goal is achieved in accordance with the claims. To measure the glucose contents in bodily fluids a dialysate of the tissue fluid freshly brought into material equilibrium is continuously fed to a measuring compartment with the aid of microdialysis. This can occur in such a way that at least one wall of the measuring cuvette is a diaphragm, or the fluid being measured is fed to the measuring cuvette by a pump system with an exchange path that is separated by a diaphragm from the solution being measured. A protein-free dialysate thus obtained from the tissue fluid reduces the cross-sensitivities, since all molecules that are larger than the separating border of the dialysate membrane and that may have a disruptive effect are held back by the membrane. Independence from the temperature can be achieved, e.g., by a “symmetrical” design with a measuring and a reference path, since temperature-dependent changes then reciprocally compensate each other.

The design of the measuring process according to the invention has the following characteristics: the modulated, quasi-monochromatic electromagnetic beams emitted from the radiation sources are split into two partial beams by a suitable beam splitter, and their intensities are detected by detectors (e.g., photodiodes) that are largely independent of wavelengths in a certain wavelength band. Their output signals (photocurrents) are transformed into voltages and these are then electronically offset to form a highly stable difference or ratio signal. Fluctuations in intensity in the source radiation are eliminated by this difference or ratio formation. Most importantly, however, the difference or ratio signals are also modulated, thereby making possible the use of lock-in amplifier technology known to prior art. Sensitivity is thus enhanced by a factor of up to 10³ as compared to conventional electronic amplifying mechanisms.

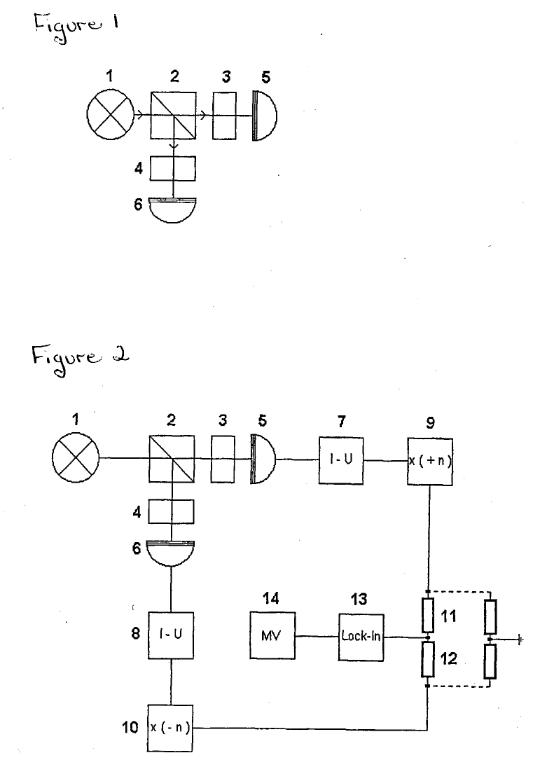

The core portion of the inventive measuring procedure and the related device is shown in FIG. 1. The essential elements are a beam splitter (2), which splits the beam produced by a radiation source or sources (1) into two beams (measuring and reference beam); a sampling cuvette (3) and a reference cuvette (4), each positioned behind the beam splitter in the direction of radiation; and two detectors (5 and 6), each of which intercepts a partial beam behind a cuvette and transforms the beam's intensity into electrical signals. The latter are then prepared for use in a signal processing unit.

FIG. 2 shows an inventive embodiment of the measuring arrangement. The time-dependent intensity (I(t)) of the (practically) monochromatic source radiation of the radiation source (1, e.g., a laser diode) is modulated in sine fashion:

I(t)=I₀·sin(ω·t)+I_{K}

At any given time, material of the type under analysis is kept unchanged inside the reference cuvette (4), in a concentration that is similar or identical to the concentration in the sampling cuvette. The intensity-splitting ratio of the beam splitter (2) is so selected that the two intensities I_{M}(t) and I_{R}(t) that strike the detectors (5 and 6) when there is no substance for detection in the material located in the sampling cuvette (3) have the same value; this is the so-called equalized state. The two current-voltage transformers (7 and 8) that follow transform the photocurrents produced by the detectors into voltages (U_{M}(t) and (U_{R}(t)) and simultaneously separate the direct current portion. An essential feature of the invention is represented by the two following multipliers (9 and 10) with amplifications n and −n. One of the two multipliers inverts the signal; the second serves the purpose of analog compensation for any signal periods occurring in the first signal inverter, no matter which of the two has the amplification n or −n. The two output voltages of the multipliers are used as distribution voltages for a Wheatstone bridge or as distribution voltages in a voltage distributor measuring circuit; this is another essential feature of the inventive device. Whereas in the equalized state the bridge voltage (U_{Br}) which is measured between the two resistors (11 and 12) and the zero potential of the electronic circuit equals zero, a bridge voltage (U_{Br}) that differs from zero occurs during each analysis (the material being analyzed is present in the sampling cuvette).

The bridge voltage during the analysis equals:

$$\begin{matrix}{U}_{Br} = A \cdot {U}_{M} ( t ) + {U}_{R} ( t ) \\ = A \cdot n \cdot {U}_{o} \cdot sin ( ω \cdot t ) - n \cdot {U}_{o} \cdot sin ( ω \cdot t ) \\ = ( A - 1 ) \cdot n \cdot {U}_{o} \cdot sin ( ω \cdot t )\end{matrix}$$

A is the ratio between the values of U_{M}(t) during the analysis (for the given concentration of the material under analysis) and the equalized state.

The bridge voltage can be modified by changing the source intensity of the radiation source; it (its amount) is independent of the position of the sample or reference cuvette, which are interchangeable. The bridge voltage brought about by the substance being analyzed is detected by a lock-in amplifier (13), whose output signal (a direct current voltage U_{GI}) is passed on to a test values processor (14), which would most simply consist of a display device. The following applies for the output signal of the lock-in amplifier:

U_{GI}=(2/π)·(A−1)·n·v·U_{O}

v is the signal amplification of the lock-in amplifier. The sensitivity of the terminal signal of the entire measuring arrangement is the first derivative of this function with respect to the magnitude A, which is dependent on the concentration of the substance being analyzed.

dU_{GI}/dA=(2/π)·n·v·U_{O}

The sensitivity can be adjusted by increasing the source intensity, as well as by varying the amplification factors n and v. It is limited here only by the signal-noise ratio in the signal processor and, in particular, is independent of changes in intensity that are brought about by absorption.

The advantage achieved by the inventive measuring arrangement rests in the simple and symmetric design, which (largely) eliminates both intensity fluctuations in the source radiation and changes in absorption due to temperature changes in the measured material. Furthermore it makes possible the use of the lock-in amplifier technology, whose generally known advantages can be utilized, i.e., the detection of very small signal changes with simultaneous elimination of external (electrical or optical) disturbances, which influence the measuring or reference path.

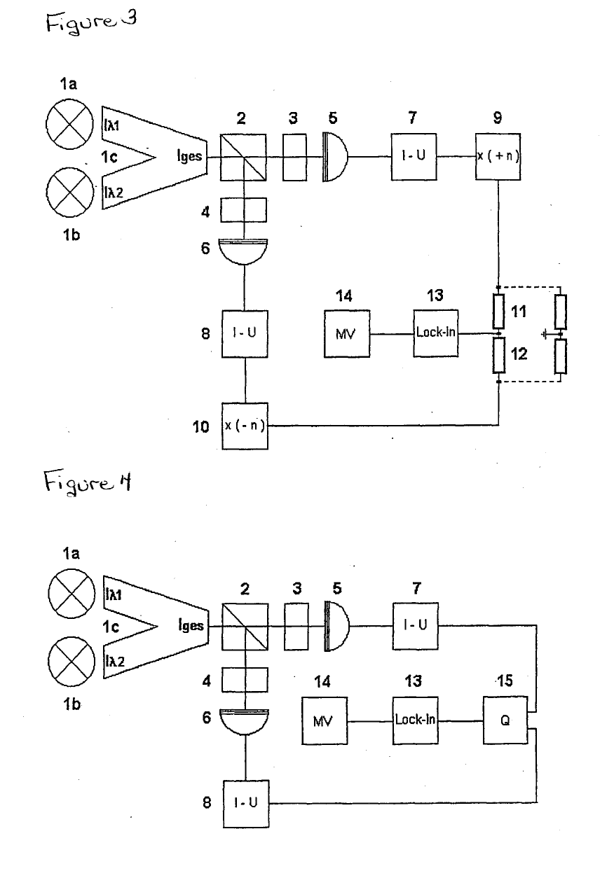

FIG. 3 shows a preferred and expanded inventive embodiment of the measuring system in the form of a dual-wavelength spectrometer. Here the two quasi monochromatic source radiations from the radiation sources (1a and 1b, e.g., laser diodes) have different wavelengths. The time curves for the intensities of the source radiation are modulated in sine fashion and have an unchangeable temporal phase displacement of 180° (=π). These are all essential features of the present measuring arrangement. The two output intensities then have the following time curve:

I₁(t)=I_{0,1}·sin(ω·t)+I_{K,1}

I₂(t)=I_{0,2}·sin(ω·t±π)+I_{K,2}=−I_{0,2}·sin(ω·t)+I_{K,2}

The two beams are combined into one beam with the total intensity I, e.g., by coupling the individual beams entering the two individual inlets of a “Y” optical conductor (1c) with static distribution of the optical conductor fibers. The combined beams then leave the common outlet of the optical conductor, and the intensities are combined additively. If the two amplitudes of the intensity addends (I_{0,1} and I_{0,2}) are equal, the luminous intensity (I(t)) at the outlet of the optical conductor is constant.

The material being detected is continuously present in unchanged form inside the sealed reference cuvette (4), in a concentration that is comparable to the anticipated concentration in the material being actually measured. The splitting ratio (I_{M}/I_{R}) of the radiation intensities at the beam splitter (2) is so selected that in equalized state, i.e., with material for measuring inside the sampling cuvette (3) absent the substance being detected (i.e., when the material analyzed has differing contents in the reference and in the sampling cuvettes, respectively), the same intensity nonetheless strikes the detectors (5 and 6). The intensities are intercepted by the detectors, whose photocurrents are transformed into voltages by two current-voltage transformers (7 and 8), while the direct current portions are simultaneously separated. The multipliers that come next in the sequence (9 and 10), with amplifications n and −n, amplify these voltages, so that voltages U_{M}(t) and U_{R}(t) occur at the multiplier outlets. The two output voltages (U_{M}(t) and U_{R}(t)) are employed as bridge voltages in a Wheatstone bridge or as distribution voltages in a voltage distributor measuring circuit. Whereas in equalized state the bridge voltage (U_{Br}) between the two resistors (11 and 12) and the zero potential of the circuit is zero, during the analysis (i.e., the material under analysis is present in a given concentration in the measuring cuvette) a bridge voltage that differs from zero establishes itself. During the analysis there are intensity changes in the measuring path that are induced by the material being detected; in the reference path, on the other hand, the intensity (I_{R}(t)) that strikes that detector remains constant. The bridge voltage during analysis is calculated as:

$$\begin{matrix}{U}_{Br} = {U}_{M} ( t ) + {U}_{R ( t )} \\ = n \cdot A \cdot {U}_{o} \cdot sin ( ω \cdot t ) - B \cdot {U}_{o} \cdot sin ( ω \cdot t ) - n \cdot ( {U}_{o} \cdot sin ( ω \cdot t ) - {U}_{o} \cdot sin ( ω \cdot t ) ) \\ = ( A - B ) \cdot n \cdot {U}_{o} sin ( ω \cdot t )\end{matrix}$$

A and B are conversion factors for the two wavelengths between the values of U_{M}(t) in the analysis (for the given concentrations of the analyzed material) and U_{M}(t) in the equalized state.

B is proportional to A; if B is substituted with x·A(B=x·A), then

U_{Br}=A·(1−x)·U_{O}·sin (ω·t)

The design is symmetrical; the sampling cuvette (3) and the reference cuvette (4), and thus the measuring path and the reference path, are interchangeable. The bridge voltage induced by the analyzed material is recorded by a lock-in amplifier (13), and the latter's output signal U_{GI} is transmitted to a processing unit for the measured values. The following applies:

U_{GI}=(2/π)·A·(1−x)·n·v·U_{O}

v is the signal amplification of the lock-in amplifier. The sensitivity of the output signal of the overall measuring arrangement is the first derivative of this function with respect to magnitude A, which is dependent on the concentration of the substances under analysis.

dU_{GI}/dA=(2/π)·(1−x)·n·v·U_{O}

It is dependent on both the source intensity of the radiation source and on the amplification factors n and v, and is thus changeable. Furthermore, it is dependent on the factor x, i.e., on the absorption difference between the two wavelengths.

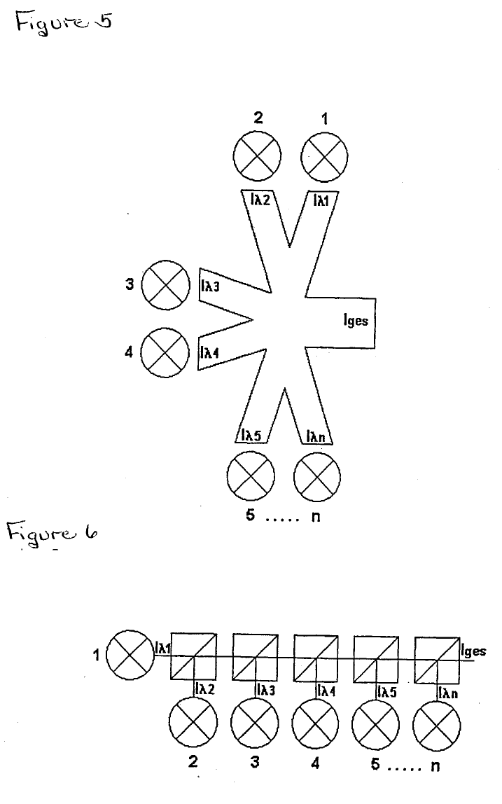

FIG. 4 shows a modification of the measuring arrangement depicted in FIG. 3. In place of the multipliers (9 and 10) and the following measuring bridge or voltage distribution circuit (11 and 12) in the measuring arrangement in FIG. 3, an electronic ratio generator (15) can be employed. The output voltages of the two current-voltage transformers (7 and 8) serve here as input signals for the ratio generator. The direct-current portions are not separated.

For the output voltage of the ratio generator (U(t)) the following therefore applies:

$$\begin{matrix}U ( t ) = {U}_{M} ( t ) / {U}_{R} ( t ) \\ = [ {U}_{o} \cdot sin ( ω \cdot t ) \cdot A \cdot ( 1 - x ) + {U}_{K} \cdot A \cdot ( 1 + x ) ] / [ 2 \cdot {U}_{K} ]\end{matrix}$$

Following immediately after the ratio generator is a lock-in amplifier (13), whose output signal U_{GI} is passed on for further processing to a processing unit (14) for test values. For U_{K}>U_{O}>0 the following applies:

U_{GI}=(1/π)·A·(1−x)·v·U_{O}/U_{K}

v is the signal amplification of the lock-in amplifier. The sensitivity of the output signal of the overall measuring arrangement is the first derivative of this function with respect to the magnitude A, which is dependent on the concentration of the substance under analysis.

dU_{GI}/dA=(1/π)·(1−x)·v·U_{O}/U_{K}

As in the previous configuration, it is dependent on the source intensity and the amplification factor v, as well on the factor x (absorption difference between the two wavelengths) and consequently is also changeable.

FIGS. 5 and 6 show an expanded version of the measuring arrangements of FIGS. 3 and 4. Instead of the two monochromatic radiation sources it is possible to use a larger number of radiation sources. The intensities of the individual radiation sources can be made to overlap, e.g., by multi-arm optical conductors (FIG. 5) or by dielectrical beam-splitters (FIG. 6). Here the temporal phase displacement of the individual source intensities for three sources is equal to 2·π/3(120°), for four sources π/2(90°), and for k radiation sources in general (2·π/k, kεN). The ability to transfer the solution depicted in FIGS. 3 and 4 to a form employing a plurality of sources lies within the expertise of the specialist.

The advantage achieved by using a number of sources (simultaneous measurement for a plurality of wavelengths) consists both in a distinct enhancement of specificity and in the fact that the signal change is increased (through subtraction) with the appropriate selection of individual wavelengths (increase and reduction in transmission).

Other advantages are represented by a design that is both compact and symmetrical. Only two photosensitive elements are needed for the detection of k sources and for the elimination of fluctuations in the source intensities; at the same time, changes in absorption caused by temperature fluctuations are eliminated.

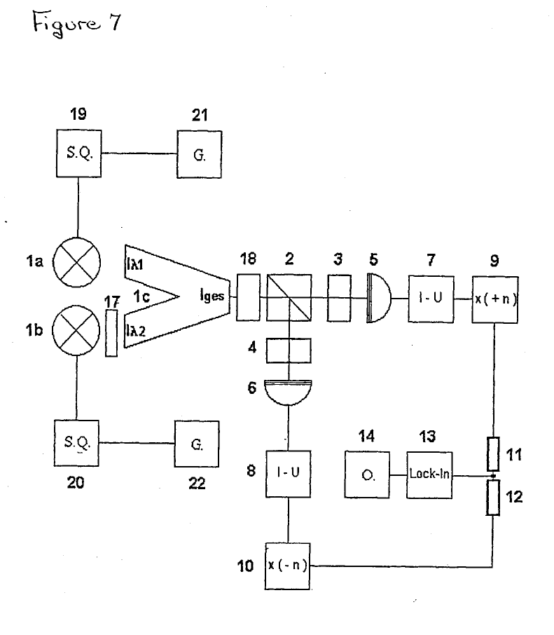

An example of a device for implementing the method according to the invention is depicted in FIG. 7. The figure shows the scheme for an arrangement of components in accordance with the device shown in FIG. 3. The radiation sources (1a) were a laser diode (“FNLD 1450”, LASER GRAPHICS, Kleinostheim) with a wavelength of 1450 nm and an optical output of max. 4 mW and (1b) a LED (“LED 16”, LASER GRAPHICS, Kleinostheim) with a wavelength of 1580 (±150) nm and an optical ouptut of max. 1.2 mW. Both radiation sources were supplied with power sources (19 and 20: “Model LDC 220”, PROFILE, Karlsfeld) whose output currents received a sine-shaped curve from two function generators (21 and 22: “HM 8131-2”, HAMEG, Frankfurt am Main). Positioned behind the LED (1b) was an interference filter (17: “Model 42-6167”, COHERENT, Dieburg) with a central wavelength of 1620 nm. The radiations from the LED and the laser diode were each coupled into one side of a Y-shaped optical conductor (1c; a special manufacture with a diameter of 1 mm, L.O.T.-ORIEL, Darmstadt) of quartz fiber permeable to infrared radiation, and the combined beam, which leaves the common end of the optical conductor, was bundled by a collimator lens system (18: “DIV-THR-Optik-LWL”, LASER 2000, Wessling) and focused. The following beam-splitting prism (2: “44-3861”, COHERENT, Dieburg) split the beam into two equally powerful partial beams, which penetrated the adjacent cuvettes (3 and 4; special manufactures with a layer thickness of 1 mm and a volume of 50 μl, HELLMA, Müllheim). Serving as detectors (5 and 6) were two InGaAs-PIN-photodiodes (“G 5832-01”, HAMAMATSU, Herrsching), while the adjoining current amplifiers (7 and 8: “DLPCA-100”, FEMTO, Berlin) reinforced the photocurrents. The output signals of the current amplifiers were reinforced by voltage amplifiers (9 and 10: “4-channel-INH-amplifier”, SCIENCE PRODUCTS, Hofheim), and their output voltages were applied to two resistors (11 and 12: “metal layer 1.2 MΩ”, RS, Mörfelden-Walldorf). The voltage that occurred between the two resistors towards zero circuit was recorded by a lock-in amplifier (13: LIA-MV-150”, FEMTO, Berlin), and the output signal was displayed by a digital storage oscilloscope (14: “9304”, LECROY, Heidelberg).

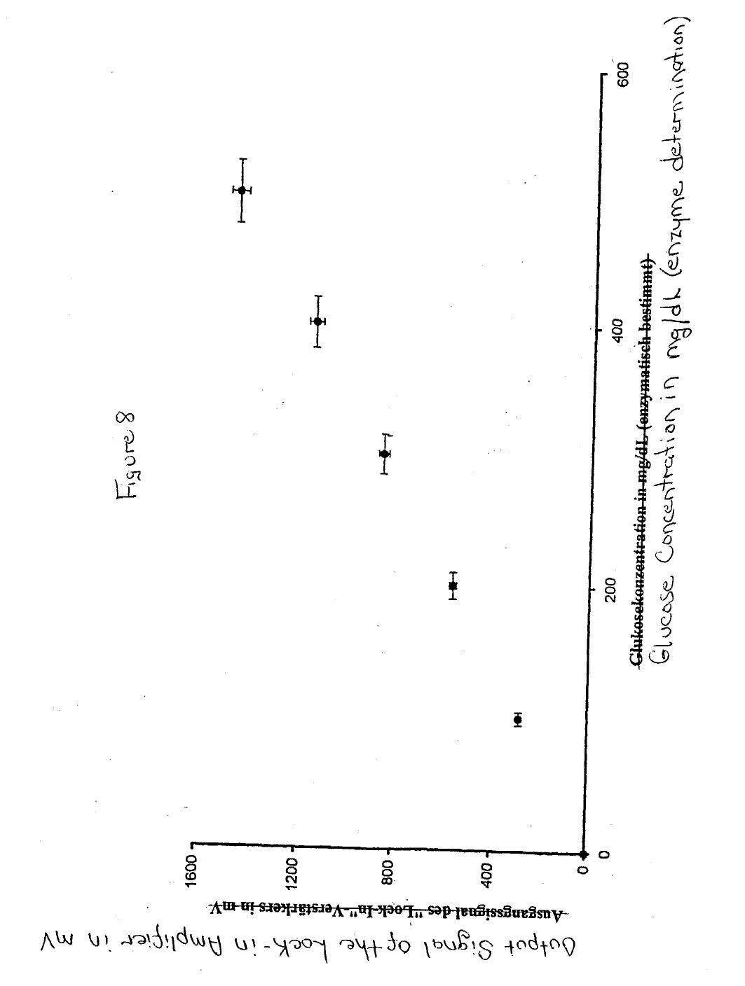

The exemplary device in FIG. 7 yielded very precise measurements, inclusive of measured material with a low concentration of the substance being analyzed. FIG. 8 shows a calibration curve produced with this device for D(+)-glucose. An absolute error of about 5 mg/dL emerges from the measurement for a concentration of 100 mg/dL in the range of the calibration curve.

1. A method for spectrometric measurement that is stable over time and is readily reproducible, specifically the measurement of the concentrations of components of aqueous solutions, in particular the dialysates of interstitial tissue fluids, in which method a measuring beam is divided into two partial beams by a beam-splitter, one partial beam is conducted through a measuring cuvette and the other partial beam is conducted through a cuvette that is filled with a reference solution, the luminous intensities of both partial beams are measured and the measuring signals are fed, if necessary after suitable amplification, to a symmetrical signal processing component, wherein the intensity of the measuring beam fluctuates in uniformly periodic fashion over time, within the signal processing component the signal of each partial beam is first fed to a multiplier, and one multiplier performs a signal inversion, which is followed by the process of subtraction or ratio formation.

2. A method according to claim 1, wherein the measuring beam is a monochromatic radiation.

3. A method according to claim 1, wherein the measuring beam consists of a plurality of overlapping monochromatic beams.

4. A method according to one of claims 1 to 3, wherein the differential or the ratio signal is demodulated.

5. A method according to one of claims 1 to 4, wherein the demodulated signal is measured by a processing unit for test values and the concentration is determined by means of a calibration curve created there.

6. A device for spectrometric measurement that is stable over time and is readily reproducible, specifically the measurement of the concentrations of components of aqueous solutions, particularly the dialysates of interstitial tissue fluids, which device consists of a radiation source (1) with an intensity that fluctuates in uniformly periodic fashion over time, a beam-splitter (2), a measuring cuvette (3) positioned in the measuring beam portion, a reference cuvette (4) which is positioned in the reference beam portion and is filled with a quantity of the unchanged substance being analyzed, in a concentration comparable to that anticipated for the solution being measured, detectors (5 and 6) positioned in the beam paths behind the sampling and reference cuvettes, for measuring the luminous intensity of the partial beams, current-voltage transformers (7 and 8) for transforming the signals into electrical signals, a multiplier (9 and 10) for each of the two partial signals, one of which multipliers inverts the signal, and a device for processing and evaluating the signals.

7. A device according to claim 6, wherein the radiation source (1) delivers a monochromatic beam.

8. A device according to claim 6 or 7, wherein the radiation source (1) consists of a plurality of radiation sources, whose beams are combined into a single beam by means of suitable optical components.

9. A device according to claim 8, wherein the optical components that combine the individual beams into a single beam are dielectric beam-splitters or optical conductors.

10. A device according to one of claims 6 to 9, wherein the signal-evaluating device is a Wheatstone bridge or a voltage distribution circuit (11 and 12).

11. A device according to one of claims 6 to 9, wherein the signal-evaluating device is a ratio generator (15).

12. Devices according to one of claims 6 to 11, wherein a lock-in amplifier (13) and a test values processing unit (14) are positioned behind the signal-evaluating device.

13. A device according to claim 12, wherein the test values processing unit (14) consists of a microcomputer and a visual display unit.

14. A device according to claim 13, wherein the test values processing unit (14) consists of a microcomputer with a bidirectional telemetric transmission unit.

15. A device according to one of claims 6 to 14, wherein the measuring cuvette (3) is separated from the solution being measured by a diaphragm or is attached to a pump system with an exchange path, which is separated by a diaphragm from the solution being measured.

16. The use of the device according to claims 6 to 15 for measuring operational parameters or for monitoring and regulating process sequences, particularly in chemical manufacturing processes.

17. The use of the device according to claims 6 to 15 in micro-reactors.

18. The use of the device according to claims 6 to 15 in a miniaturized design as an implantable glucose sensor.
